(19) United States
(12) Patent Application Publication
(10) Pub. No.: US 2004/0133850 A1
(43) Pub. Date: Jul. 8, 2004

(54) System and method for securely composing, storing, and delivering digital media

(76) Inventors: Mark J. Nitzberg, Cambridge, MA (US); Jan Egleson, Cambridge, MA (US)

Correspondence Address: MARK J. NITZBERG, 45A FAYERWEATHER ST., CAMBRIDGE, MA, 02138, US

(21) Appl. No.: 10/336,335

(22) Filed: Jan. 6, 2003

(51) Int. Cl. G06F 15/00

(52) U.S. Cl. 715/500.1

(57) ABSTRACT

The illustrative embodiment of the present invention enables the delivery of digital media source material from a content provider to a consumer in a manner designed to protect the finished composition and digital media distribution quality source material from being distributed to unauthorized users. A digital media content provider delivers source material that is less than distribution quality (“edit quality”) to a distributor. The distributor forwards the edit quality material to an outside editor for editing. The editor performs the editing process and returns the edited material to the distributor in the form of a composition list. The distributor combines the composition list with additional distribution quality digital media source material to produce a finished composition. By applying just-in-time inventory concepts to the process, the finished composition is produced only as needed and is sent to the consumer upon completion. By limiting the amount of time the finished product is present at the distributor, and limiting the transmission of distribution quality digital media source material, the method of the present invention limits the opportunity for proprietary content to be inadvertently or illegally distributed to unauthorized users.

### FIELD OF THE INVENTION

The illustrative embodiment of the present invention relates generally to the composition, storage and delivery of digital media content, and more particularly to a system and method of enhancing the security of the process of composing, storing and delivering digital media from source materials stored in remote locations.

### BACKGROUND

Conventional methods for composing and publishing media products (i.e., play-lists of popular songs, presentations incorporating images and video clips, training materials composed of multimedia learning objects, films composed of visual and sound elements, etc.) currently fail to protect intellectual property rights to source materials adequately. Typically, source materials are sent from a content provider to a distributor. The distributor, which may be an individual or a company, has responsibility for overseeing the completion of a finished digital media product from digital media source material. The source materials are sent from the content provider to the distributor as high quality versions capable of being used by end consumers. The distributor then compiles the materials into a finished product and distributes the product to the consumer.

Unfortunately, the current distribution of digital media source materials leads to a number of problems. Once the source materials are outside of the direct control of the content provider, the security of the materials is dependant upon any data protection mechanisms set up by the distributor and any third parties, such as editors, working for the distributor. The editor may be an individual, company or automated process which assembles the source material components into proper alignment in order to create a finished digital media product. Source materials may be re-used and re-distributed by careless or adversarial parties without permission from the owner. Since the digital media source materials are received by the distributor already in a distribution quality format, any unauthorized loss of control over the source materials greatly diminishes the value of the digital media source material to the content provider. Additionally, if the distributor stores a great deal of finished product as inventory, the inventory is subject to unauthorized use.

### BRIEF SUMMARY OF THE INVENTION

The illustrative embodiment of the present invention enables the delivery of digital media source material from a content provider to a distributor in a manner designed to protect the source material from being distributed to unauthorized users. Digital media source material is delivered in multiple components, some of which are distribution quality and some of which are in an “edit-quality” format that is less than distribution quality. Distributors send the edit-quality components to outside editors. The distribution quality components remain with the distributor. The editors compile the edit-quality components into a composition list which is returned to the distributor. The distributor combines the composition list with the distribution quality digital media source material previously received from the content provider to produce a just-in-time finished composition ( i.e.: a final product ). The finished composition is then delivered to consumers. The use of a just-in-time production of finished compositions further limits unauthorized access to the finished product.

### BRIEF SUMMARY OF THE DRAWINGS

FIG. 1 depicts an environment suitable for practicing the illustrative embodiment of the present invention;

FIG. 2 is a flowchart of the sequence of steps followed by the illustrative embodiment of the present invention to distribute digital media source material.

### DETAILED DESCRIPTION

The illustrative embodiment of the present invention enables the delivery of digital media source material from a content provider to a consumer in a manner designed to protect the finished composition and distribution quality source material from being distributed to unauthorized users. Distribution quality digital media source material is capable of appearing in a finished product without material change. Digital media source material is the raw material, such as digital audio data or digital video data, which is used to form digital media products. A digital media content provider delivers digital media source material to a distributor. The delivered source material includes both distribution quality material and source material that is less than distribution quality (“edit quality”). The distributor forwards the edit quality material to an outside editor for editing. The distribution quality material remains with the distributor. The editor performs the editing process using the edit quality material and returns the edited material to the distributor in the form of a composition list. A composition list is a separate creation from the source material that indicates the alignment or sequence of source materials necessary to create a finished digital media product. Examples of information contained in a composition list include the order of soundtracks (audio sequences), or a direction to lay a particular soundtrack over a particular film clip sequence. The distributor combines the composition list with additional distribution quality digital media source material to produce a finished composition. By applying just-in-time inventory concepts to the process, the finished composition is produced only as needed and is sent to the consumer upon completion. By limiting the amount of time the finished product is present at the distributor, the method of the present invention limits the opportunity for the final product to be inadvertently or illegally distributed to unauthorized users.

The present invention allows for the creation and distribution of digital media source materials in a way that respects the proprietary nature of the source materials, compositions of those materials in the form of composition lists (these are separate creations from the source materials themselves), and consumable versions of the compositions. The invention lets content providers publish higher-valued, or “distribution-quality” versions of source materials (i.e., video clips, sound clips, film clips, images, sound effects, interactive programs, multimedia learning objects, music clips, music samples, 3-d representations of objects and virtual environments, maps, etc.) through trusted distributors to consumers. To make their materials available to editors without compromising the control of distribution of the intellectual property, content providers also publish lower-valued or protected “edit-quality” versions of the source materials (i.e., graphic symbols, words, phrases, images, key frames, cartoons, low-resolution video or sound clips, screen shots) to editors through distributors. Editors work on their local machines, accessing materials from distributors directly, or through intermediaries called editing providers who may provide interactive editing facilities, to create compositions of the source materials. Because edit-quality materials often require substantially less storage space and computer power to manipulate than distribution quality materials, interactive editing facilities may provide powerful editing features (image processing filters, sound-processing, video overlays, etc) within low-powered computing environments such as a web-browser program on a computer. The compositions are published to distributors. Finally, distribution-quality versions of the complete compositions are assembled by distributors and transferred to consumers, preferably in a protected format.

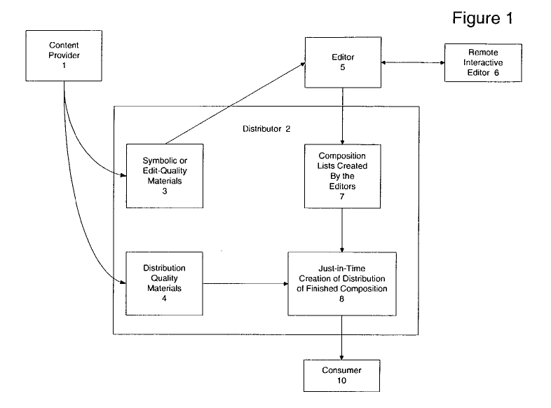

FIG. 1 depicts an environment suitable for practicing the illustrative embodiment of the present invention. A content provider 1 transmits digital media source materials to a distributor 2 in both symbolic or edit-quality form 3 and in distribution quality form 4. The distributor 2 uses an editor 5 to edit the edit-quality source materials into a pre-production format called composition lists 7 which are then returned to the distributor. In one aspect of the illustrative embodiment of the present invention, the editor 5 uses a remote interactive editing system 6 to piece together the edit quality components 3 into composition lists 7. In another aspect of the illustrative embodiment of the present invention, the editor 5 performs the compilation of the edit quality components 3 into composition lists 7 on a local machine. The distributor 2 then provides a finished composition 8 to a consumer 10 on demand. The finished composition 8 is compiled by the distributor 2. The distributor 2 combines the composition lists 7 with the distribution quality materials 4 that were previously received from the content provider 1 to produce a finished product. The system allows for metering such that royalty payments may be calculated and distributed appropriately to relevant editors 5 and content providers 1 when compensation is received for a finished composition 8. By restricting the production of the finished composition until orders are received, and restricting the dissemination of the distribution quality digital media source material, the possibility of unauthorized users acquiring proprietary content is diminished.

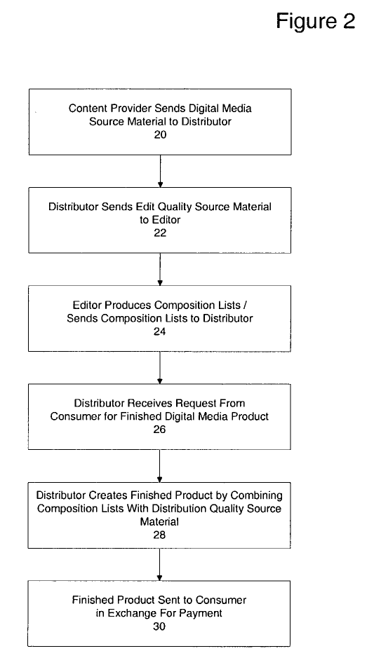

FIG. 2 is a flow chart of the sequence of steps followed by the illustrative embodiment of the present invention to produce finished compositions of distribution quality digital media. The sequence begins when the content provider 1 sends digital media source material to a distributor 2 (step 20). The digital media source material includes both edit-quality material 3 and distribution quality material 4. The distributor 2 sends the edit quality material 3 to an editor 5 for editing (step 22). The editor 5 edits the edit quality material 3 into composition lists 7 which are returned to the distributor 2 (step 24). Subsequently, the distributor 2 receives a demand from a consumer 10 for a digital media product (step 26). The distributor 2 uses the composition lists 7 and the distribution quality digital media source material 4 to produce a finished composition (step 28). The finished composition 8 is sent to the consumer 10 in exchange for payment (step 30). Those skilled in the art will recognize that the sequence of events may be altered without departing from the scope of the present invention. For example, the distributor 2 may depart from a just-in-time production model and pre-produce finished compositions 8 prior to receiving a consumer request for a finished product (although this requires the finished inventory product to be protected from unauthorized distribution). Alternatively, the consumer 10 may request a digital media product prior to the beginning of the editing process instead of after its completion as outlined above.

In one embodiment applying to distributed video creation and sharing by film enthusiasts, the content providers own and wish to make available the source materials used to make a film. The source material used to make a film includes various takes of each shot, voice soundtracks, music tracks, effects filters, transitions, special effects overlays that are to be composited into shots, scripts, and so forth. In this embodiment, these source materials are published to one or more distributors, who hold them in digital form (on computer disk, tape, compact disk, DVD, in computer memory, or other digital storage medium) and make them available on demand via digital communications media (Internet, local area net, Ethernet, wireless network, fiber optic network, or other digital communications medium). Notably, the materials are stored with “tags” (sometimes called meta-data) that help to identify the data type, intended use, origin, length, format, cost and other data pertinent to understanding the characteristics, value and cost of the source material for use in a composition.

In this embodiment, the materials are published to distributors in two forms: one distribution-quality form (DV, Digi-beta, compressed video, high-quality digital sound format; high-resolution image formats; and generally formats that offer the quality desired for distribution), and one edit-quality form (in the case of video, a low-resolution video format such as 320×240 pixel MPEG with an obstructive stripe across the picture in most frames, and analogously for other data formats). An editing provider runs an interactive editing system on a computer and allows editors to access the system from remote terminals (an Internet web service, for example). In this embodiment, the editing system might provide the tools familiar to a film editor: a timeline-based graphic interface with multiple channels for visual and audio components. During editing, the source materials are available in edit-quality form only. The output of the editing system is a composition list, a variant of the film industry Edit Decision List (“EDL”) which includes the meta-data necessary to construct the final film from the distribution-quality source materials available from one or more distributors. When an editor is satisfied with a composition, then he or she can choose to publish its composition list to one or more distributors.

To view the film, a consumer requests it from a distributor. The distributor calls up the composition list for the finished film, and composes the final product from the distribution-quality source materials, following the codes of the composition list to determine which tracks should be combined over time and how they are to be combined. The final result is then made available to the consumer via digital communications medium in a protected format. Examples of protected formats include streaming RealVideo, QuickTime, QuickTimeTV, and Microsoft ASF which are difficult for ordinary computer users to capture and redistribute.

Another embodiment applies to distributed creation and sharing of so-called “learning objects,” small, reusable chunks of instructional material in digital, easily-distributable form. These objects may take many forms ranging from text and pictures to interactive multimedia programs. Content providers control repositories of learning objects for distribution to authors of training materials. The content providers may wish to serve in the role of distributors as well as content providers, in which case the process of “publishing to distributors” takes place within their organization. In system terms, the learning objects are the source materials, and the authors of training materials are editors. Content providers publish the learning objects in a distribution quality format as well as an edit-quality format to distributors. The edit-quality format of a learning object may be a symbol or name. For example, a learning object that is an interactive multimedia tool for training an auto mechanic in the replacement of an air filter may be, in edit-quality format, the words “interactive training tool, air filter replacement,” accompanied with a single image of the tool's appearance on a computer screen.

In one embodiment, the author combines published source materials in an organized fashion to create a final training product, for example, a car maintenance training guide for a particular automobile. Using an interactive editing program on a computer, the content author constructs the final training product by combining the desired learning objects in the desired order. The author may add structure, such as a table of contents and index, tests which determine the user's comprehension of the material, and other embellishments. When complete, the author then publishes the result in the form of a composition list. The composition list may be published in the form of XML (Extensible Markup Language). End consumers can then request the training product from a publisher, and the publisher can construct and deliver the training product in multiple ways which deter unauthorized redistribution. One way to prevent unauthorized distribution is through server-side delivery; a web-based service that provides media in small portions at a time, for example page-by-page, to the consumer, so that the entire product is not available to the consumer for redistribution.

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. Practitioners of the art will realize that the sequence of steps depicted in the figures may be altered without departing from the scope of the present invention and that the illustrations contained herein are singular examples of a multitude of possible depictions of the present invention.

We claim:

1. A method, comprising the steps of:
providing digital media source material to a digital media distributor, said digital media source material including distribution quality digital media source material and edit quality digital media source material, said edit quality digital media source material having a lower quality than said distribution quality digital media source material;
forwarding said edit quality digital media source material to an editor;
editing said edit quality digital media source material to produce a composition list, said composition list being a compilation sequence for producing a finished digital media product;
sending said composition list to said distributor; and
using said composition list and said distribution quality digital media source material to produce a finished distribution quality digital media product.

2. The method of claim 1 wherein said distribution quality digital media source material is not received by said digital media distributor until said distributor receives said composition list.

3. The method of claim 1 wherein a remotely controlled editing system is used to edit said edit quality digital media source material.
